(19) United States
(12) Patent Application Publication
(10) Pub. No.: US 2022/0048313 A1
(43) Pub. Date: Feb. 17, 2022

(54) Color Changing Protective Cover for a Writing Instrument

(71) Applicant: Loretta Gibson, Waynesboro, GA (US)

(72) Inventor: Loretta Gibson, Waynesboro, GA (US)

(21) Appl. No.: 17/232,317

(22) Filed: Apr. 16, 2021

Related U.S. Application Data
(60) Provisional application No. 63/066,266, filed on Aug. 16, 2020.

(51) Int. Cl. B43K 23/00; B43K 29/08; G01N 21/94; G01N 21/78

(52) U.S. Cl. CPC B43K 23/00; G01N 21/78; G01N 21/94; B43K 29/08

(57) ABSTRACT

The present invention relates generally to the field of writing utensil accessories. More specifically, the present invention relates to a color changing protective cover for a writing instruments, such as a pen, pencil, marker, etc. The uniquely designed and initially transparent cover changes color when harmful pathogens, germs, bacteria, or viruses are detected on the surface of the cover to prevent an individual from using a writing implement with a contaminated surface/cover. The invention also ensures that each writing instrument is clean before use, thereby greatly reducing the possibility of the individual contracting germs, pathogens, viruses, bacteria from using the writing instrument.

### CROSS-REFERENCE TO RELATED APPLICATION

The present application claims priority to, and the benefit of, U.S. Provisional Application No. 63/066,266, which was filed on Aug. 16, 2020 and is incorporated herein by reference in its entirety.

### FIELD OF THE INVENTION

The present invention relates generally to the field of writing utensil accessories. More specifically, the present invention relates to a color changing protective cover for a writing instrument, such as a pen, pencil, marker, etc. The uniquely designed and transparent cover changes color when harmful pathogens, germs, bacteria or viruses are present on the surface of the cover to prevent an individual from using a writing instrument with a contaminated surface/cover. The invention also ensures that each writing utensil is clean before use, thereby greatly reducing the possibility of the individual contracting germs, pathogens, viruses, bacteria from the writing utensil. The device may also be comprised of a dispenser that dispenses the covers via an opening, wherein a user can separate one cover from another via a perforated top and bottom edge. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

Various germs, viruses, bacteria, and other harmful airborne pathogens are often present in the environment, and on numerous everyday surfaces. Said germs are too minuscule in size to be seen with the unaided human eye, and as such it is nearly impossible for an individual to determine if pathogens, germs, bacteria or viruses are present on a surface of an object that they are about to touch or in the air of a building/room. Further, harmful pathogens and bacteria often easily transfer from one person to the other through infected surfaces which are frequently touched, and through the air via particulates. As such, pathogens, viruses, germs and bacteria can readily cause the transmission and spread of diseases or viruses amongst people. This is especially true in the time of a pandemic, wherein diseases can easily live on and be spread by frequently touched surfaces.

In an effort to prevent such transmissions, frequently used surfaces, such as tables, chairs, writing implements, and the like, are frequently sanitized via a disinfecting spray, disinfecting moist toilette or disinfecting liquid. Unfortunately, such sanitizing means and techniques may not always be readily available to clean a surface before use, especially if the surface is used frequently by many different users. Additionally, frequent manual cleaning of publicly used surfaces is a frustrating and tiresome job, and there is always the possibility that infected spots on surfaces will be missed, as the pathogens, germs, viruses and/or bacteria present on these surfaces are not visible to the naked eye as noted above.

Further, writing implements in particular, such as pens, pencils, crayons, markers and the like, that are used in public areas are oftentimes contaminated with germs, viruses, pathogens, bacteria and other undesirable microbes. Additionally, these objects may not be able to be constantly cleaned before they are used by another person, especially if used in a busy setting where individuals are often using the writing utensil to, for example, sign a document (e.g. a restaurant receipt). This inability to adequately and continuously sanitize said writing implements may then lead to the transmission of harmful pathogens, germs, and viruses, and therefore cause the spread of serious illness amongst various individuals.

In an attempt to combat the challenges of adequately sanitizing a writing utensil at public locations such as offices, schools, hospitals, or other locations of the like where writing implements are frequently used, barriers/covers such as tissue paper may be applied to writing instruments in an attempt to protect their outer surface from contamination. However, it is difficult to properly and completely cover the surface of the writing utensil, which often leads to germ transmission and spread of diseases. Further, said barriers are often smooth, and make it difficult to properly grip the utensil to write neatly and effectively.

Therefore, there exists a long felt need in the art for a convenient method of cleaning and sanitizing publicly used writing instruments, such as pens, pencils or the like. There is also a long felt need in the art for an easily replaceable means of covering writing instruments such that the writing instruments are adequately sanitized and prevent an individual from contracting or spreading germs, viruses, bacteria, and/or pathogens from the surface of infected writing instruments. Moreover, there is a long felt need in the art for a writing implement cover which alerts an individual to the presence of harmful pathogens, germs, bacteria, viruses or the like on its surface, and that makes it easy to firmly grip the writing instrument during use. Additionally, there is a long felt need in the art for a cover which keeps writing instruments safe in public places, such as offices, schools and the like, and that prevents the transmission of germs, viruses, pathogens and bacteria amongst people coming into contact with the writing instrument. Finally, there is a long felt need in the art for a protective cover for a writing instrument that is relatively inexpensive to manufacture, and that is both safe and easy to use.

The subject matter disclosed and claimed herein, in one embodiment thereof, comprises a color changing protective cover for a writing instrument comprising a generally cylindrical transparent cover that further includes a continuous longitudinal opening therein. The continuous longitudinal opening extends from an upper opening to a lower opening, wherein the diameter of the bottom opening is less than the diameter of the upper opening. The protective cover is further comprised of two perforated stitching lines on the top surface of the cover that form a pocket wherein a writing instrument can be inserted into the pocket via an upper hole or opening in the pocket. Once the instrument is secured within the pocket, the tip of the writing instrument may extend through a lower opening in the cover to allow the user to write with the instrument while it is enclosed within the protective cover. As such, when a pathogen, germ, virus or bacteria is present on the surface of the cover, the color of the cover changes from a transparent or translucent state to a bright color to alert a user that the cover is not sanitary, contains a plurality of germs, bacteria, pathogens and/or viruses, and should be replaced.

In this manner, the novel color changing protective cover for a writing instrument of the present invention accomplishes all of the forgoing objectives, and provides a relatively safe, easily-replaceable, convenient and cost-effective solution for completely covering a writing utensil, such as a pen, pencil, marker, crayon or the like, thereby preventing the transmission of germs from one individual to another via touching the surface of a contaminated writing instrument. Further, the protective cover is user friendly as it does not require the user to exert a great amount of effort or labor to sanitize the writing implement as would be required using previous practices, as noted above. The protective cover further indicates the presence of invisible harmful pathogens, germs, diseases, viruses, and bacteria on the surface of pens, pencils, or other writing utensils, thereby protecting users from coming into contact with said harmful organisms.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a protective cover for a writing instruments. The cover is comprised of a generally cylindrical and cannulated body having a top surface that is further comprised of a pocket for receiving the writing instrument. The pocket has an opening near the first end of the cover that allows a writing instrument to be inserted into the pocket and be protected from germs, bacteria, pathogens, etc. The second end of the cover is also comprised of an opening that allows the tip of the writing instrument to protrude through the bottom surface of the cover to allow the writing instrument to be used as intended. The transparent or translucent cover further changes color to alert a user when bacteria, viruses, pathogens, germs, etc. are detected on the surface of the protective cover.

The protective cover is also preferably comprised of a perforated top and a bottom edge that allows the cover to be connected to other covers within a dispenser such that a user may easily remove and tear a single cover from the dispenser of covers in order to apply it to the writing instrument. More specifically, the dispenser may house a perforated roll of protective covers for a writing instrument such that a single cover may be pulled by a user and torn at the perforation present between said protective cover and the subsequent protective cover.

In another embodiment of the present invention, the portable cover may be adapted for use with a portable electronic device. The cover would be applied over the electronic device and change color to alert a user when bacteria, viruses, pathogens, germs, etc. are detected on the surface of the cover. In this embodiment, the protective cover would be touch enabled such that a user can operate the electronic device and/or touch-based device while the cover is applied over the same.

In a further embodiment of the present invention, a method of protecting a portable instrument, such as a writing instrument or portable electronic device, from bacteria and viruses by applying a physical cover is disclosed. The method is comprised of the initial step of applying and/or covering the instrument or device with the protective cover of the present invention. Subsequent steps of the method include using the instrument or the device while the protective cover is applied, checking the color of the protective cover to detect whether any germs, pathogens, viruses, or bacteria are present on the protective cover, and removing and/or replacing the protective cover before use of the instrument or device if the color changes to a different color, thereby indicating the presence of contamination.

The protective cover for writing instruments of the present invention is particularly advantageous due to the fact that the protective cover can be used and applied on/to any writing instrument, can be replaced easily, is lightweight, cost-effective and eliminates the possibility of an individual using an infected writing instrument or other device. The protective cover of the present invention also offers a simple method of keeping a writing implement or other device free of germs, bacteria, pathogens, viruses and the like despite the same being used in public places, such as offices, schools and other environments.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a color changing protective cover for a writing instrument of the present invention in accordance with the disclosed architecture, wherein the protective cover is installed on a writing instrument;

FIG. 2 illustrates a perspective view of one potential embodiment of a color changing protective cover for a writing instrument of the present invention in accordance with the disclosed architecture, wherein the protective cover is comprised of an adhesive pull tab;

FIG. 3 illustrates an enhanced perspective view of one potential embodiment of the bottom surface/second end of the color changing protective cover for a writing instrument of the present invention in accordance with the disclosed architecture, and installed on a writing instrument; and

FIG. 4 illustrates a perspective view of one potential embodiment of a color changing protective cover for a writing instrument of the present invention being dispensed from a dispenser in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a protective cover for a writing instrument, such as a pen, pencil or the like, that ensures it is clean and sanitized for public use and is available at all times. There is also a long felt need in the art for an easily replaceable means of covering a writing instrument to prevent an individual from contracting or spreading germs, viruses, bacteria, and/or pathogens from the surface of infected writing instruments. Moreover, there is a long felt need in the art for a writing implement cover which alerts an individual if the writing implement cover contains harmful pathogens, germs, bacteria, viruses or the like on its surface, and that makes it easy to firmly grip the writing instrument during use. Additionally, there is a long felt need in the art for a protective cover that prevents the transmission of germs, viruses, pathogens, and bacteria amongst people coming into contact with the writing instrument, and that is relatively inexpensive to manufacture and both safe and easy to use.

The present invention, in one exemplary embodiment, is comprised of a color changing protective cover for a writing instrument. The transparent or translucent cover has an integral pocket that a writing utensil can be placed inside of via a continuous opening in the top of the pocket. The bottom surface of the protective cover is comprised of an opening to allow the tip of the writing instrument to protrude out from the body of the cover in order to permit the writing instrument to function as intended. The protective cover is further comprised of a material that is capable of changing color when the surface of the cover comes in contact with or otherwise detects the presence of contamination, such as bacteria, viruses, pathogens, germs and the like. More specifically, the change of color indicates the presence of germs, viruses, pathogens, and/or bacteria on the protective cover and that the instrument is not currently safe to use. The protective covers may be presented as single use devices, or may be part of a larger perforated roll that is dispensed from a dispenser, wherein individual covers may be separated from the larger roll by tearing the same along the perforations.

In an alternative embodiment of the invention, the unique protective cover may be specifically designed for use with electronic devices, such as telephones, computer keyboards, computer mice, card readers, etc. The cover is further comprised of a material that is capable of changing color when the surface of the protective cover comes in contact with bacteria, viruses, pathogens, germs or the like. The protective cover may further be adapted to be used with a touch-sensitive electronic device so that the electronic device may still be used despite being protected by the cover.

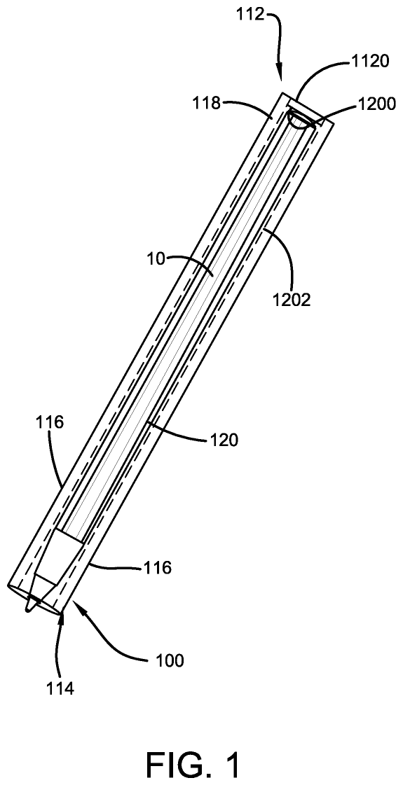

Referring initially to the drawings, FIG. 1 illustrates a perspective view of one potential embodiment of a color changing protective cover 100 for a writing instrument 10 of the present invention in accordance with the disclosed architecture, wherein the protective cover 100 is installed on the writing instrument 10. More specifically, the protective cover 100 is preferably comprised of a generally transparent/translucent, semi-rigid/flexible, elongated body 110 having a first end 112, a second end 114, and a top surface 118 having a pocket 120. The body 110 is preferably comprised of a material that allows the protective cover 100 to change color from transparent/translucent to a differing color when germs, viruses, pathogens, or bacteria are detected upon the surface of the body 110. For example, and not by way of limitation, the color of the body 110 may change to a bright red once a virus, bacteria, germ, and/or pathogen is detected on at least one portion of the surface of the body 110. The color change of the body 110 indicates to a user that the writing utensil 10 upon which the cover 100 is applied is not safe to use, and that the user should change the cover 100 before using the writing utensil 10 to prevent transmitting or contracting germs, viruses, pathogens, bacteria, and the like. Notwithstanding, the color change is not limited to red, and any other suitable color may be used. As such, when the color of the protective cover 100 remains transparent or translucent, the user knows that the writing utensil 110 is not contaminated and is safe to use. In another embodiment of the present invention, the body portion 110 may be infused with an antibacterial coating that enables the material of the cover 100 to change color when it comes in contact with a bacteria, germ, virus, or pathogen, rather than the actual material of the body 110 itself.

The protective cover 100 may be made available in different sizes to accommodate user need and/or preference, and the exact size, measurement, construction and design specifications of the unique protective cover 100 of the present invention may vary upon manufacturing depending on the type of device (e.g. writing instrument or electronic device) the protective cover 100 will be used to protect. Further, the protective cover 100 may further be coated or infused with a fragrance or scent, or any one or more of a plurality of differing grip textures such as, but not limited, to grooves, knurling, protrusions, spikes, etc. to aid a user in gripping the protective cover 100 and the writing instrument 12 protected thereby.

As noted above, the body portion 110 is also comprised of a pocket 120 located near the top surface 118. More specifically, pocket 120 may be integrally formed with the body portion 110. Alternatively, the pocket 120 may be fixedly attached to the top surface 118 via a plurality of stitching 1202, or may also be attached to the top surface 118 via an adhesive means. The pocket 120 is further comprised of an opening 1200 at the top of the pocket (i.e., adjacent to the first end 112 of the body 110). The opening 1200 allows a writing instrument, such as a pen 10, to be inserted into the pocket 120 and thus be adequately covered and protected against pathogens, germs, bacteria, viruses and the like by the pocket 120. In an alternative embodiment of the present invention 100, the pocket 120 may be adequately shaped and sized to enclose a plurality of different electronic devices such as, but not limited to, telephones, computer keyboards, computer mice, card readers and the like. Alternatively, the pocket 120 may be eliminated and the writing instrument 10 may merely reside within the body portion 110 itself, wherein the body portion comprises similar type openings with at least one opening being large enough to accept the writing instrument and a second opening that retains the same.

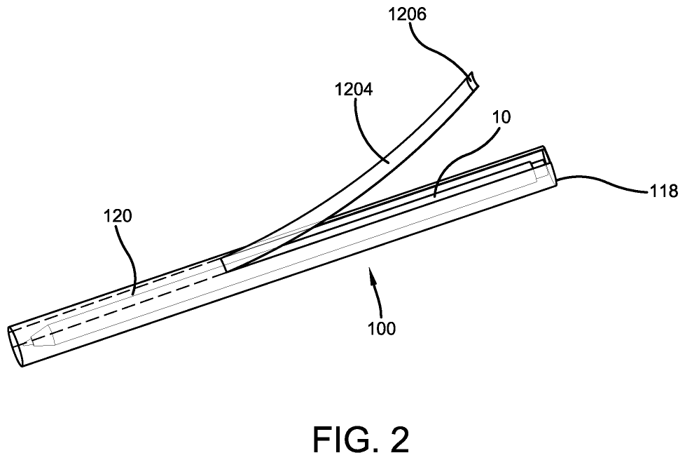

FIG. 2 illustrates a perspective view of one potential embodiment of a color changing protective cover 100 for a writing instrument 10 of the present invention in accordance with the disclosed architecture, wherein the protective cover 100 is comprised of an adhesive pull tab 1206. The bottom surface of the pull tab 1204 is preferably comprised of an adhesive backing that allows the pull tab 1204 to adhere to the top surface of the pocket 120 until needed. However, the tab 1204 can be pulled upwards and away from the pocket 120 to allow a user to more easily insert a pen 10 or other writing instrument into the pocket 120. In order to grip the tab 1204, the tab 1204 may further be comprised of a pull tab portion 1206 that allows the user to grip the tab 1204 more effectively, and also reduces the amount of the body portion 110 touched by a user while inserting a writing instrument 10 into the cover 100, thereby lowering the possibility of contamination.

In a further embodiment of the protective cover 100, the pull tab 1206 may be comprised of a perforated edge (not shown) that attaches the tab 1206 to the adhesive tab 1204 such that the pull tab 1206 can be removed after a pen 10 or other writing instrument has been inserted into the pocket 120, and the tab 1204 has been adhered to the pocket 120 to seal the instrument 10 within the pocket 120. This in turn eliminates the portion of the body 110 (the pull tab 1206) that was touched and potentially contaminated by one user, such that any germs, bacteria, pathogens, or viruses from the user that came in contact with the body 110 while the user was inserting a pen 10 does not spread to other subsequent users of the pen 10.

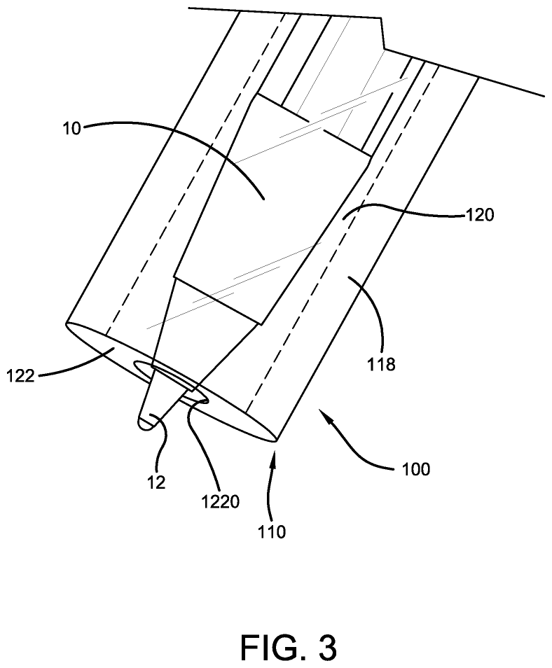

FIG. 3 illustrates an enhanced perspective view of one potential embodiment of the bottom surface/second end 122, 114 of the color changing protective cover 100 for a writing instrument 10 of the present invention in accordance with the disclosed architecture, and installed on a writing instrument 10. The bottom surface 122 is preferably circular in shape, but may be any other contemplated shape, such as triangular, rectangular, square, oblong/oval, etc. Further, the bottom surface 122 may be contoured to match the shape of the writing instrument or pen 10. Further, as noted above, the bottom surface 122 is comprised of a continuous opening 1220 therein that allows the tip 12 of the pen 10 or other writing instrument to protrude outwardly from the body 110 such that the tip 12 can contact a writing surface in order to function as intended. The opening 1220 also has a diameter that is less than that of opening 1200 of the first end 112, such that the pen 10 or writing instrument is retained within the protective cover 100.

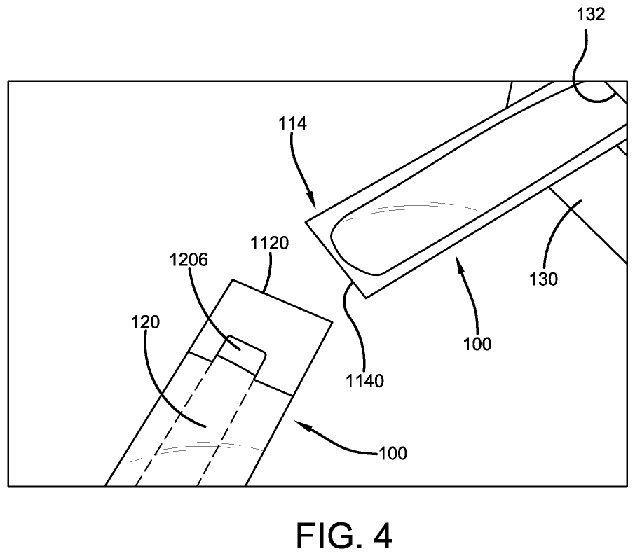

FIG. 4 illustrates a perspective view of one potential embodiment of a color changing protective cover 100 for a writing instrument 10 of the present invention being dispensed from a dispenser 130 in accordance with the disclosed architecture. More specifically, the dispenser 130 preferably houses a plurality of protective covers 100 that are removably connected consecutively to one another via a perforated top edge 1120 and bottom edge 1140 on a roll (not shown). As such, a protective cover 100 can be torn and removed from the dispenser 130 via pulling a portion of the roll through the dispenser opening 132 and tearing a single protective one cover 100 from the next consecutive cover on the roll by separating the top edge 1120 of the first cover 100 from the bottom edge 1140 of the second cover 100. Alternatively, the protective covers 100 may be individually packaged in a stack arrangement within the dispenser 130. The cover 100 may also be commercially available in a fixed amount of covers 100 per pack.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “color changing protective cover”, “color changing cover”, “cover”, and “device” are interchangeable and refer to the color changing protective cover 100 for a writing instrument 10 of the present invention.

Notwithstanding the forgoing, the color changing protective cover 100 of the present invention can be of any suitable size and configuration as is known in the art without affecting the overall concept of the invention, provided that it accomplishes the above-stated objectives. One of ordinary skill in the art will appreciate that the size, configuration and material of the color changing protective cover 100 as shown in the various FIGS. is for illustrative purposes only, and that many other sizes and shapes of the color changing protective cover 100 are well within the scope of the present disclosure. Although the dimensions of the color changing protective cover 100 are important design parameters for user convenience, the color changing protective cover 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective cover for a writing instrument comprising:
a body portion; and
a pocket for receiving the writing instrument, wherein at least a portion of the body portion experiences a change in color when a contamination is detected.

2. The protective cover for a writing instrument of claim 1, wherein the pocket is integrally formed with the body portion.

3. The protective cover for a writing instrument of claim 1, wherein the pocket is attached to the body portion by stitching.

4. The protective cover for a writing instrument of claim 1, wherein the pocket is attached to the body portion by an adhesive.

5. The protective cover for a writing instrument of claim 1 further comprising an adhesive tab.

6. The protective cover for a writing instrument of claim 1, wherein the handle is curved.

7. The protective cover for a writing instrument of claim 1, wherein the pocket comprises a first opening at a first end and a second opening at a second end.

8. The protective cover for a writing instrument of claim 7, wherein the first opening is larger than a diameter of the writing instrument to allow the writing instrument to be inserted into the pocket.

9. The protective cover for a writing instrument of claim 8, wherein the second opening is smaller than the diameter of the writing instrument to prevent the writing instrument from completely passing therethrough.

10. The protective cover for a writing instrument of claim 9, wherein a portion of the writing instrument extends through the second opening to write on a surface while a remaining portion of the writing instrument remains in the pocket.

11. The protective cover for a writing instrument of claim 1, wherein the body portion further comprises a gripping surface.

12. The protective cover for a writing instrument of claim 1, wherein the contamination is at least one of a germ, a bacteria, a virus, and a disease.

13. A protective cover and writing instrument combination comprising:
a cannulated body portion having a first end with a first opening and a second end with a second opening;
a writing instrument positioned within the cannulated body portion, wherein at least a portion of the writing instrument extends through the second opening.

14. The protective cover and writing instrument combination of claim 13, wherein the first opening is larger than a diameter of the writing instrument.

15. The protective cover and writing instrument combination of claim 14, wherein the second opening is smaller than the diameter of the writing instrument to prevent the writing instrument from completely passing therethrough.

16. The protective cover and writing instrument combination of claim 13, wherein at least a portion of the body portion experiences a change in color when a contamination is detected.

17. The protective cover and writing instrument combination of claim 13, wherein the contamination is at least one of a germ, a bacteria, a virus, and a disease.

18. The protective cover and writing instrument combination of claim 13, wherein the body portion further comprises a gripping surface.

19. A roll of protective covers for a writing instrument comprising:
a plurality of protective covers positioned end to end, wherein each of the plurality of protective covers is separated by a perforation, and further wherein each of the plurality of protective covers is comprised of a body portion that experiences a change in color when a contamination is detected.

20. The roll of protective covers for a writing instrument of claim 19, wherein the contamination is at least one of a germ, a bacteria, a virus, and a disease.
